(19) United States
(12) Patent Application Publication
(10) Pub. No.: US 2015/0379529 A1
(43) Pub. Date: Dec. 31, 2015

(54) System, service and methodology of data collection, processing, analysis and effective delivery of dashboard snapshot presentations of organized customer proprietary information on an individualized secure basis to multiple customers

(71) Applicant: Gennady Batrakov, Santa Clara, CA (US)

(72) Inventor: Gennady Batrakov, Santa Clara, CA (US)

(21) Appl. No.: 14/738,883

(22) Filed: Jun. 13, 2015

Related U.S. Application Data
(60) Provisional application No. 62/018,534, filed on Jun. 28, 2014.

(51) Int. Cl. G06Q 30/02

(52) U.S. Cl. CPC G06Q 30/0201

(57) ABSTRACT

A System, service and methodology of data collection, processing, analysis and effective delivery of dashboard snapshot presentations of organized customer proprietary information on an individualized secure basis to multiple customers includes an interface and communications component easily accessible by each customer for securely and efficiently communicating with the System service provider to submit raw customer data and to receive the dashboard presentations, a data processing and delivery component for developing the presentations of each customer's data in individualized snapshot formats selected by the customer, and an analytical component for enabling the System host to quickly analyze the customer's processed data and to timely deliver the customer specific results as requested by the customer via a System website, or the like, easily accessible by each customer on a secured, as wanted, basis using any type of electronic communications device capable of providing graphical visualization of the dashboard presentations.

### BACKGROUND OF THE INVENTION

1. Field of the Invention

The present invention relates generally to business intelligence data gathering and processing for dashboard presentation, and more specifically to a multi-user, network based system and methodology for receiving and processing remote user data for return to the user in a user selected dashboard or dashboard snapshot format.

2. Prior Art

In order to successfully compete in business today, company executives must be able to obtain and rely on large quantities of business related information, be able to understand the information, and be able to respond quickly to the impact of changes reflected in the information and affecting the business. It is thus well understood that having timely, actionable information presented in an easily comprehended format can be a major asset of the company.

An important aspect of any service, marketing or manufacturing company's success in business, no matter how large or small, is demand visibility with timely performance and/or inventory adjustments. For example, many companies have hundreds or thousands, or even tens of thousands of products, items or parts (usually identified by SKU's (Stock Keeping Units), or ordering codes or logical groups of such items) for which they must capture and comprehend current status information, make management decisions, provide forecasts, and perhaps even take corrective action where necessary. There is little doubt that the ability to capture and quickly convert raw business data into an easily understandable format leads to better decision making and can be a critical factor in the success of the company.

Today's business data gathering and processing, inventory management, and forecast predictions are usually produced by complex mathematical algorithms which drive mountains of numbers and calculations. Unfortunately, use of some currently available systems is time and resource consuming, and often not very reliable because it is difficult to rely blindly on a system which provides critical numerical information based on calculations without proper validation. Errors can be costly, and negative impact can be significant, leading to a lack of confidence in both the numbers and the ability to deliver the desired information.

There are many Business Intelligence (BI) platforms on the market today offering data discovery, and they are undeniably providing a huge advancement over older systems. Such BI platforms are intended for use in processing vital information, maintaining inventories at optimum levels and enabling quick response to demand fluctuations. However, they are usually quite expensive in terms of overall cost, and many organizations using such systems fail to forecast the financial impact of change fast enough, even though the platforms provide excellent data discovery and use capabilities. In fact, many companies experience well-known issues with respect to the currently available systems; such issues generally relating to frequency and timeliness, flexibility and accuracy, transparency and accessibility of information. And all too often, the end-to-end process of use takes far too long.

In some cases, due to the increased complexity of data gathering, supply chain and other business operations, quarterly forecasts often take two-to-five weeks to finalize, and as a consequence, budgets are often not finalized until well into the actual year to which they will apply. Similarly, the time taken to produce each iteration of a forecast or budget is far too long; frequently taking days and sometimes weeks. In today's environment, the impact of change to a company's financial data often must be understood and acted upon by decision makers within the same day, or in some cases, even within the same hour.

The more modern Business Intelligence (BI) systems take note of cognitive research studies examining how the human brain processes information and demonstrating that the ability to simultaneously visualize interrelated information taken from multiple sources, empowers decision makers to more easily and clearly grasp the significance and overall meaning of an information set with greater accuracy, and provide a dashboard style of reporting that graphically depicts performance measurements and includes the ability to publish multi-object, linked reports and parameters with intuitive and interactive displays.

Presently, a host of businesses are using dashboard data visualization programs as aids to the understanding and use of their data, and are thus making better business decisions. A business intelligence dashboard (BI dashboard) is a BI software interface that provides preconfigured or customer defined metrics, statistics, insights, and visualizations into current data. It allows the end and power users of the software to quickly or even instantly view the current state of business or data analytics. In addition, the dashboards often employ visualization components such as gauges, sliders, checkboxes and maps which are frequently used to show the actual values of important measurements compared to goal or target values.

The BI dashboard is designed to allow users to receive timely visualization of their preferred BI-specific operations, eliminating requirements for manually executed queries or processes. Moreover, a BI dashboard's appearance and interface may be customized for desktop, mobile or Web/cloud users. The BI dashboard works like a standard application dashboard that gathers two or more key performance indicators (KPI) and statistics into a visual interface. When a user logs in to the BI software, the first visible page/interface/element is the BI dashboard. However, the type and amount of displayed data vary according to the BI software's available capabilities and customization.

It is now understood that data visualization, when executed properly, has major advantages over the manipulation of raw data. A well-designed dashboard allows a user to interpret the meaning and significance of his data at a glance. Using such presentation format, data taken from multiple sources, indexes, calculations, formulas etc., can be condensed into a dynamic, single, complete dashboard that can tell the history of the data (past), the current state of the company (present), and what the company might expect if no changes (future) are undertaken. Wellconstructed dashboards are also used for analytical exploration and often find gaps and uncover issues through use of data mining processes.

Existing dashboards built on Business Intelligence platforms successfully tackle difficulties with data analysis by pulling data from multiple and disparate data sources, e.g., from ERP systems, databases, data warehouses and simple spreadsheets, and allowing to create dazzling brilliant views, and are a very useful tool for conducting Business Analytics (BA); a term referring to the tools and techniques used to systematically examine any aspect of a business's performance. The examinations conducted in business analytics are typically statistical, make heavy use of data and seek to discover organizational weaknesses and strengths in order to streamline internal processes, cut costs, and increase gains.

However, even though a dashboard can be a rich business analytical visualization tool, there is still room for efficiency improvement because in order to capture spikes in demand and/or gaps in supply, every item must be examined regularly; i.e., be reviewed and analyzed daily, or item-by-item.

BI dashboards can be fully utilized by capturing detailed snapshots of data systematically; for example by recording, sorting, assembling, exploring, storing and distributing a complete collection of static snapshots to the customer. The snapshots of such abridged and yet comprehensive data on the lowest item level will usually be pre-sorted, packed into thumbnails and made ready for customer review, validation and approval. One dashboard view is good; but a “glance view” of multiple dashboard snapshots of different products already systematically pre-filtered with a repeated assignment task, organized with visualization of recommended changes is much better.

Currently available business intelligence software products are normally marketed on a licensing basis and are individually customized to meet the special needs of the licensed company. This of course means that the product acquisition and/or licensing fee expense is large, and the in-house user manpower requirement is high, thus further elevating the overall cost to the licensee. Moreover, any subsequent changes to the product to suit the changing needs of the licensee further increase the overall cost.

It is therefore a principal objective of the present invention to provide a hosted service to remote users(customers) in which all data processing is accomplished in a host facility (or facilities) to which the subscribing users communicate their data via a network connection, and the host system processes the data according to the requirements of the user in preselected dashboard(s) and streams the results back to the user in the form of snapshots, images, data tables, prescriptive analyses, recommendations and graphical visualizations thereof.

### SUMMARY OF THE INVENTION

Briefly, a presently preferred embodiment of the present invention provides a centralized System, service and methodology of data collection, analysis, processing and effective delivery of individualized dashboard snapshots of organized information to multiple customers, and includes an interface and communications component easily accessible by each customer on a secured basis for efficiently communicating with the System service provider, submitting raw customer proprietary data and receiving the dashboard presentations, a data processing and delivery component for developing customized dashboard presentations of each customer's data in individualized snapshot formats selected by the customer, and an analytical component for enabling the host to quickly analyze the customer's processed data on an individualized basis as requested by the customer. The interface component may include a system website easily accessible by each customer on a customer specific secured basis for results presentation of their information on an as wanted basis. The customer may use any type of electronic communications device capable of providing graphical visualization of the dashboard or multiple dashboards presentations.

An advantage of the present invention is that a subscribing customer/user can have its data remotely analyzed, processed and returned as a dashboard image snapshot, or a plurality of snapshots, organized and presented in a format of the customer's choosing without having to install and maintain any data processing software at its facility.

Another advantage of the present invention is that it implements a specific algorithm of automated collection and distribution of meaningful plural dashboard snapshots of “diced-and-sliced” information from the system's BI platform dashboard.

Still another advantage of the present invention is that it provides visualization at a glance of essential data points in the form of a multi-set of graphical images, dashboard snapshots and image thumbnails. It also provides timely distribution of full snapshot collections to the customer for review, further analysis and use.

The system and methodology of the present invention also provides the capability of delivering multiple sets of snapshots and thumbnails in a variety of ways; to secured synced folders (Customer—Service Provider—Customer), to smart phones, to ipads, to tablets, to web (cloud based) and by email.

The present invention can also operate as an independent entity for the collection, management and delivery of important concise information coming from dashboards.

The methodology of the present invention relieves the customer of the burden of manual human interaction with BI when reviewing information one-by-one is required in a live dashboard for each item (or set of items), and provides rapid and condensed views of all snapshots in one single object of presentation.

An additional aspect of the System and methodology of the present invention is that by providing a remotely accessible service it partially relieves a customer's Information Technology resource load, yet provides a highly skilled development and maintenance facility for the customer's business intelligence data.

The present invention also provides a specific website which is designed to manage the customer's data stream and provide an information exchange platform specifically purposed to help small customers with initial setup to link them with a dashboard template for inventory management.

Additionally, the System can provide an “ON DEMAND” feature which allows users to remotely initialize the DashboardStream System over the network and request specific dashboard visualizations through sets of images snapshots, graphical images and data points on specific items, groups of items or global level overviews. The snapshots or sets of snapshots can be delivered to an electronic mailbox, tablet, ipad or be displayed on a personal webpage. This feature can be extremely useful for an executive staff to get business updates or analyzed comprehensive views of the business in near real time at any time and from any location.

Thus, ON DEMAND feature of the DashboardStream System can be used not only for multi snapshot processing, but can also be used to request one single snapshot at a time. In a way, the DashboardStreaming process is a remote operation of the dashboard by replication of such dashboard or its parts, or any other data, into snapshot format and visualize it as an image almost instantly. Reconstruction of the dashboard and presentation of such dashboard or any other data in different picture format (i.e., jpeg, png, bmp, gif etc.) will allow a user to operate the dashboard remotely and get images of any instance through the network using the DashboardStream methodology.

The System of the present invention provides its services to customers who do not have their own Business Intelligence platform but would like to have its benefits and desired visibility of their business at a glance. Perhaps the most important advantage of this model is that it frees the customer from BI system capital investment, development and management responsibilities and costs.

The System and methodology of the present invention allows the customer to tap into Business Intelligence resources without spending huge sums of money and effort.

The System and methodology of the present invention system provides, by use of its filtering and sorting tools, responsiveness to demand changes and transparency of delivered results in the form of visual recommendations and depictions of items for corrective action by extracting and visually presenting items with recommended adjustments and/or corrective action before a projected action takes place.

The methodology and System of the present invention includes an approval step; an “Accept”, “Reject” or “Modify” mechanism for assurance and acceptance confirmation of its recommendations. Rejected recommendations for specific items will be excluded from auto-processing.

The methodology and System of the present invention implements the fastest, most economical and effortless way of accomplishing analytical information flow.

The methodology and System of the present invention provides a user defined mechanism in the form of web-based controls for setting up rules for depiction of items requiring special attention or corrective actions.

The methodology and System of the present invention provide web-based controls for identifying a specific set of items for verification, validation and analysis to be used.

The methodology and System of the present invention provide a capability and flexibility for setting daily, weekly or a specific time frame format for structured information flow and selected level of visibility.

The methodology and System of the present invention is cost-effective and designed to keep the customer aware of its business events with a relatively brief single glance of snapshots, and with minimal expenditure of time, resources and effort.

The methodology and System of the present invention bridges the gap between complexity and cost, affordability and meaningful data discovery.

The methodology and System of the present invention is versatile and opens doors for any kind of future prescriptive analysis. It is not limited to a single dashboard and offers a highly detailed level of information reporting back to the customer with the highest level of confidence.

The methodology and System of the present invention is flexible and can be adapted to work with any existing Business Intelligence platform on the market.

The methodology and System of the present invention provides completeness of data visualization as images recorded for a full spectrum of items or a defined set of product offerings. An implementation of the present invention is estimated to generate up to tens of thousands of images daily on each System server. Some percentage of this number is anticipated to be filtered (depicted) with corrective action for customer approval.

Recording of multiple static snapshots of data on a lowest item (SKU) level allows additional data mining, systematic processes and procedures to be applied based on specific information derived from its elements—i.e. recommendations, inventory adjustments, categorization, classification, labeling, tagging, grouping, sorting, alerting, warning, ranking and more. In addition, historical snapshot storage enhances data maintenance.

These and other objectives and advantages of the present invention will become apparent to those skilled in the relevant art after reading the following detailed disclosure of the embodiments illustrated in the several figures of the Drawing.

### DETAILED DESCRIPTION OF THE DRAWING

The application the contains at least one drawing executed in color. Copies of this patent application publication with color drawing(s) will be provided by the Office upon request and payment of the necessary fee.

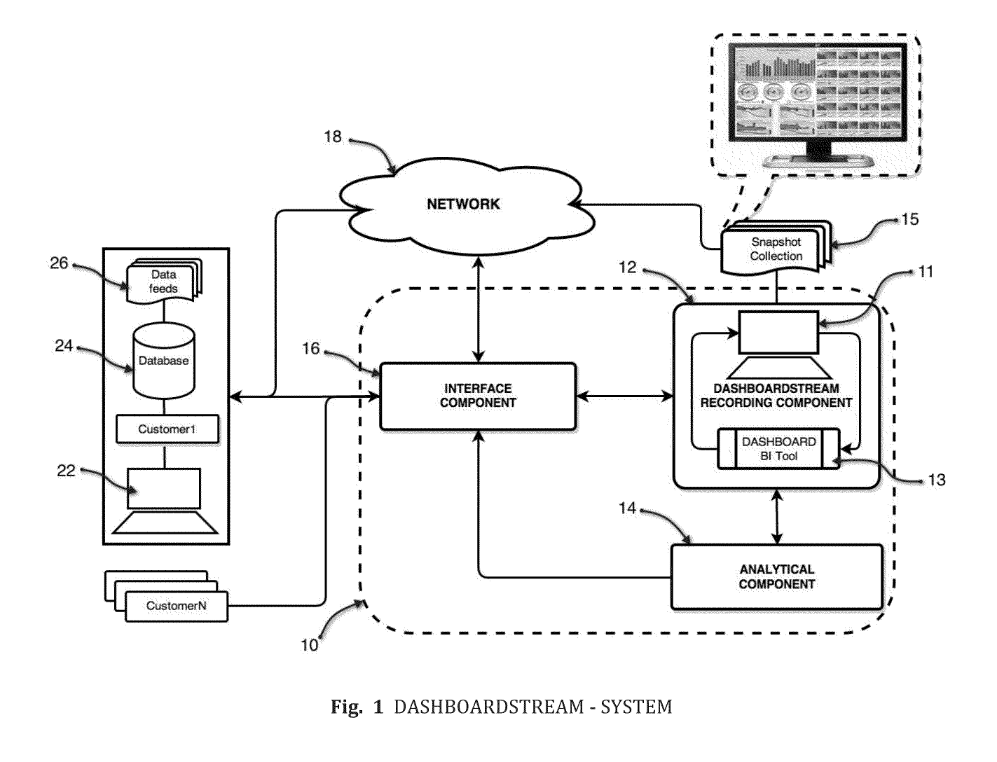

FIG. 1 is a schematic diagram depicting a network based business intelligence data gathering- and presentation System and method in accordance with an embodiment of the present invention;

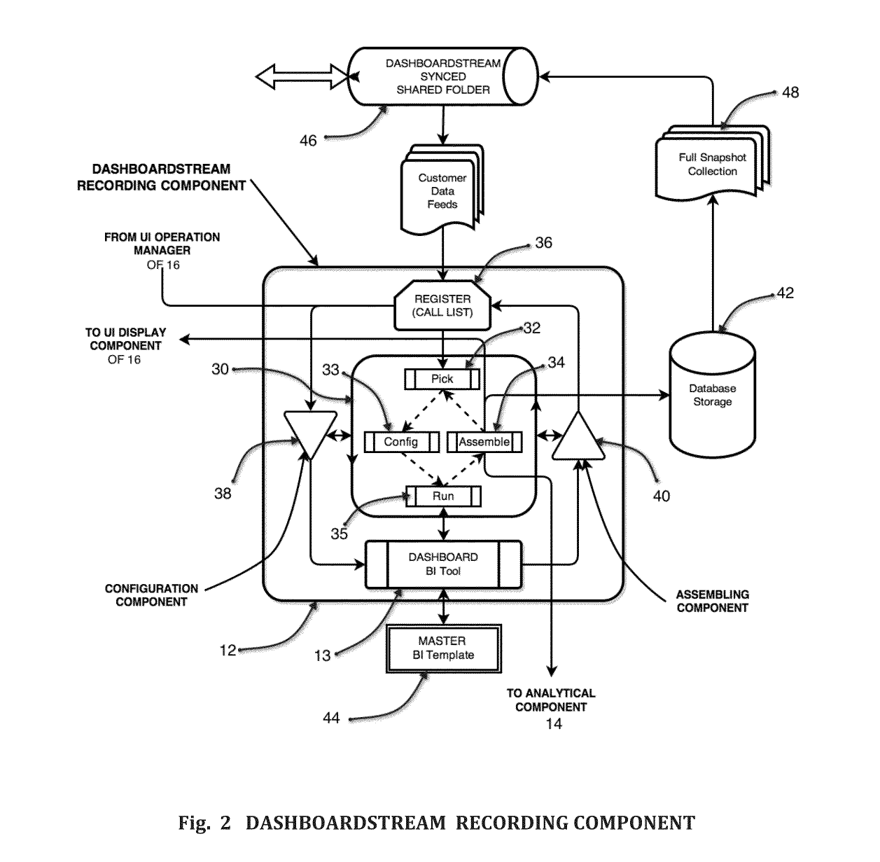

FIG. 2 is a diagram schematically depicting an embodiment of a data Processing and Recording component included in the System of FIG. 1;

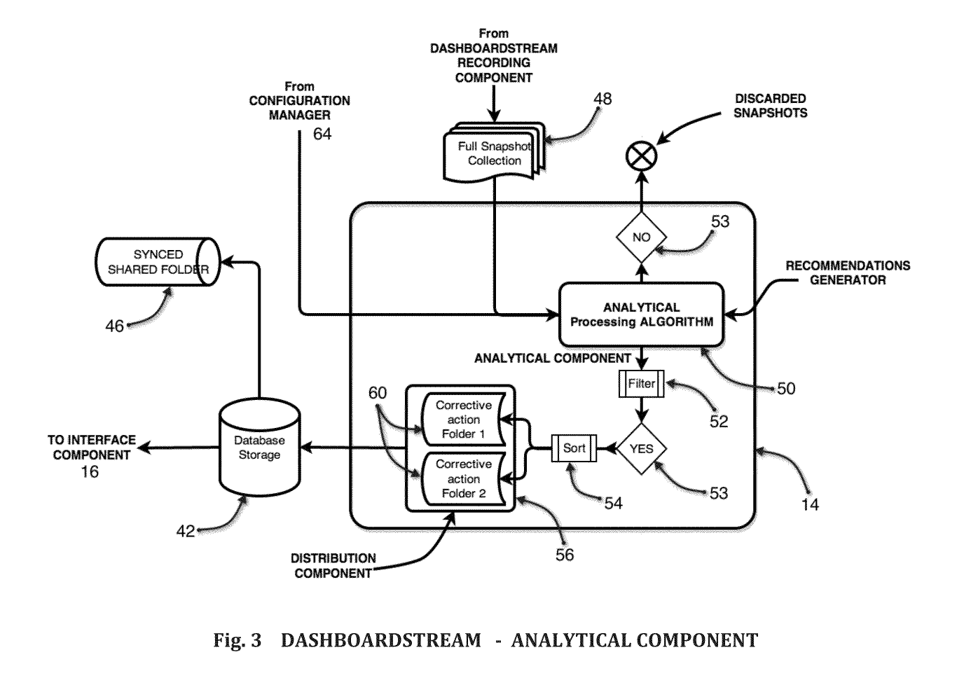

FIG. 3 is a diagram schematically depicting an embodiment of an Analytical Component as included in the System of FIG. 1;

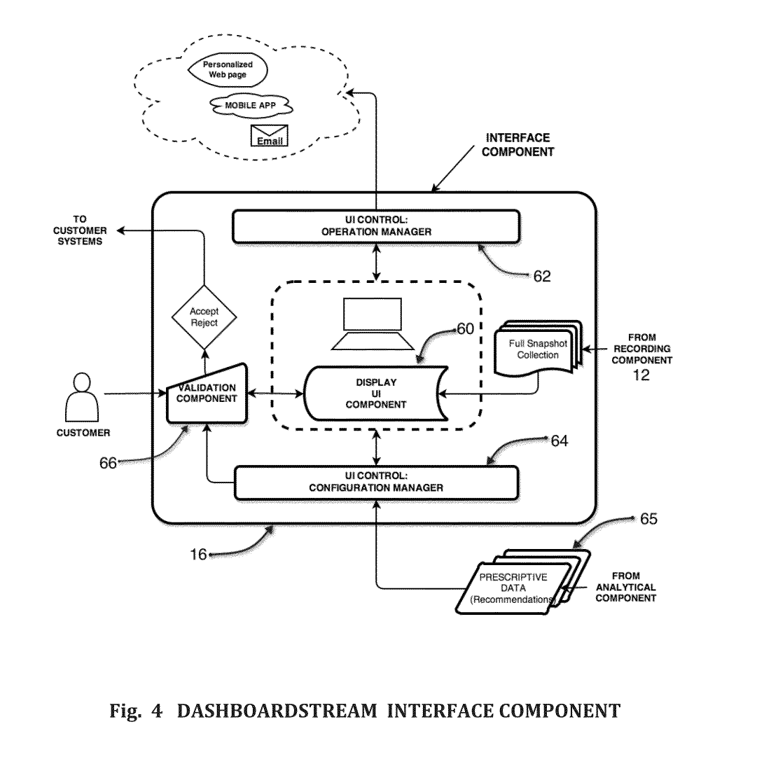

FIG. 4 is a diagram schematically depicting an embodiment of a an Interface Component as included in the System of FIG. 1;

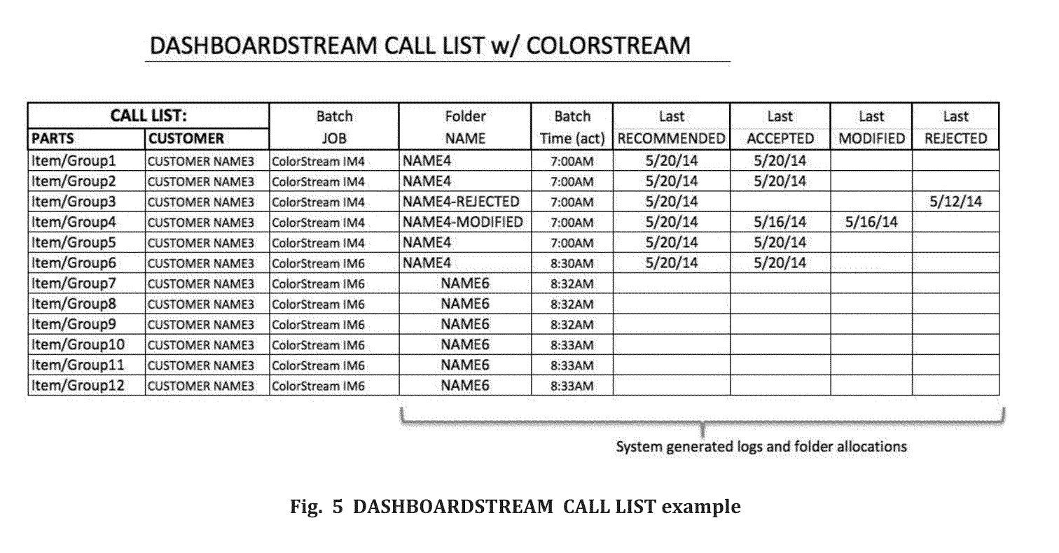

FIG. 5 is a Call List example chart of a type used in the Processing and Recording Component embodiment illustrated in FIG. 2;

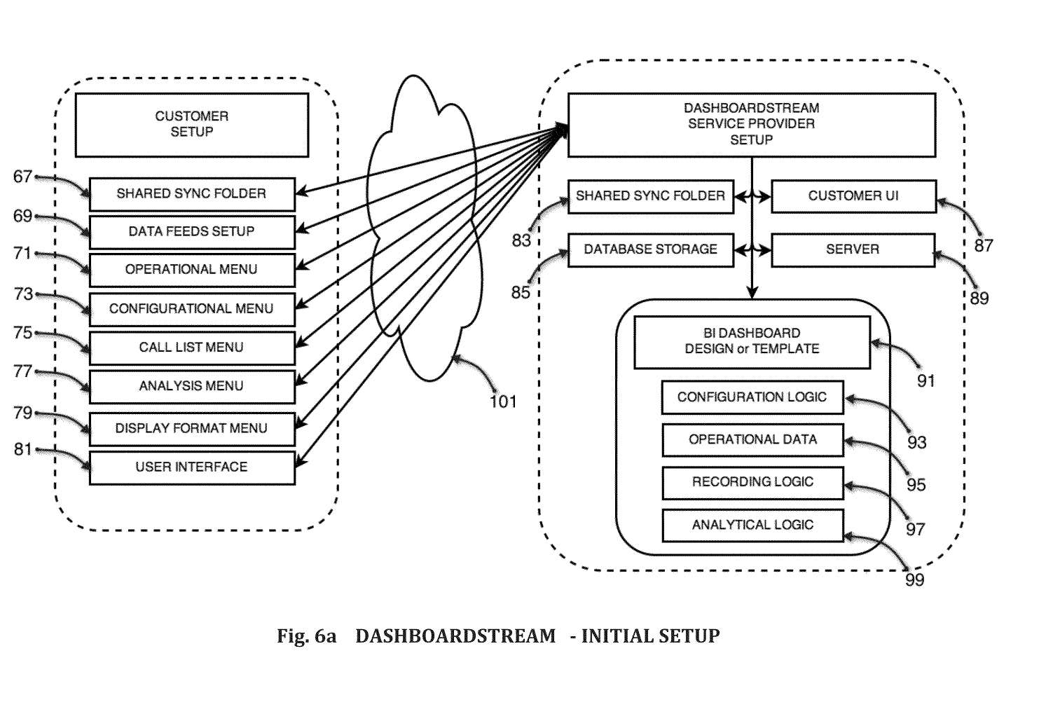

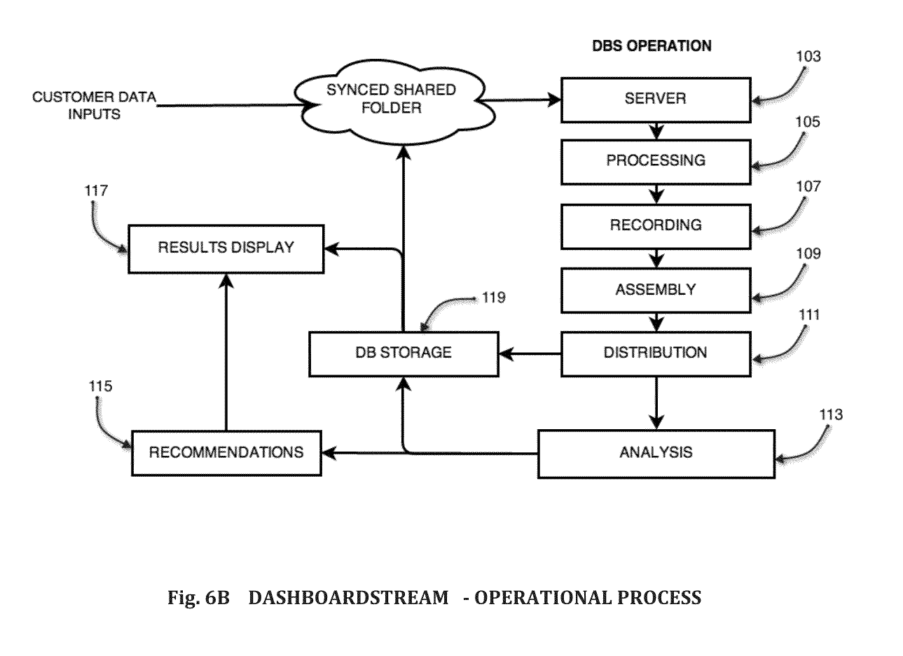

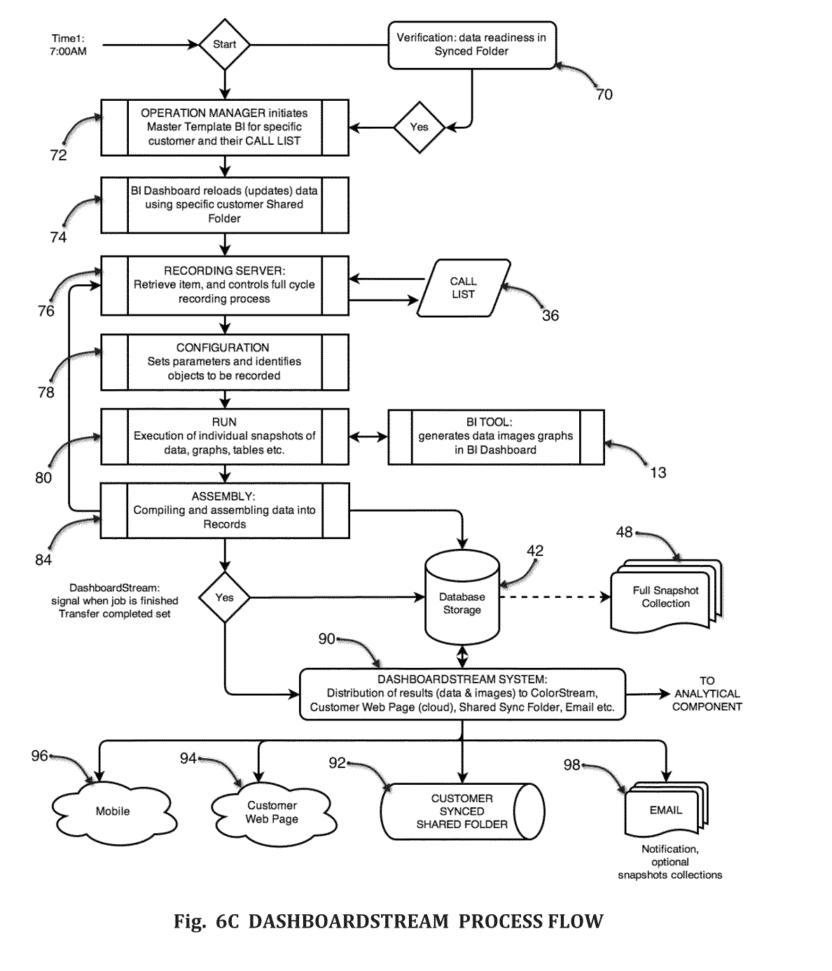

FIG. 6A is a diagram schematically illustrating an initial customer Setup process implemented by the System depicted in FIG. 1;

FIG. 6B is a diagram schematically illustrating in broad form an operative process implemented by the System depicted in FIG. 1;

FIG. 6C is a Process Flow diagram schematically illustrating the operative process generally illustrated in FIG. 6B and implemented by the System depicted in FIG. 1;

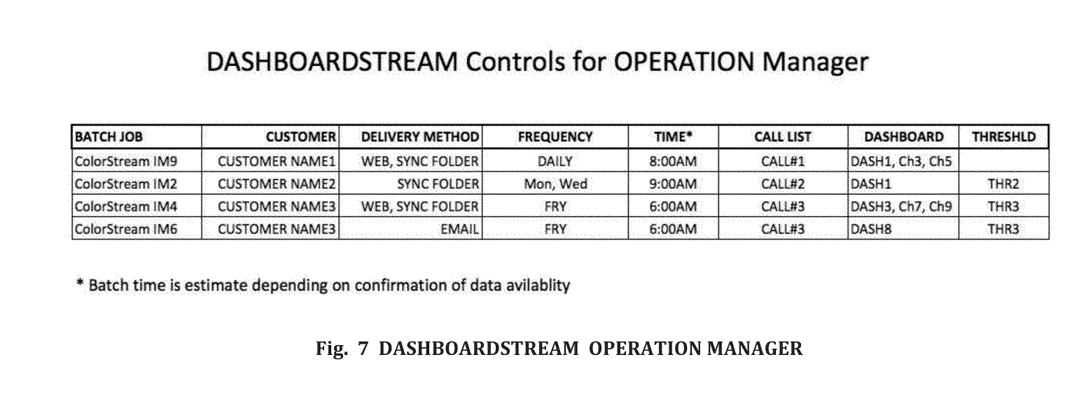

FIG. 7 is a Control Chart of the type used by the Operation Manager depicted in FIG. 4;

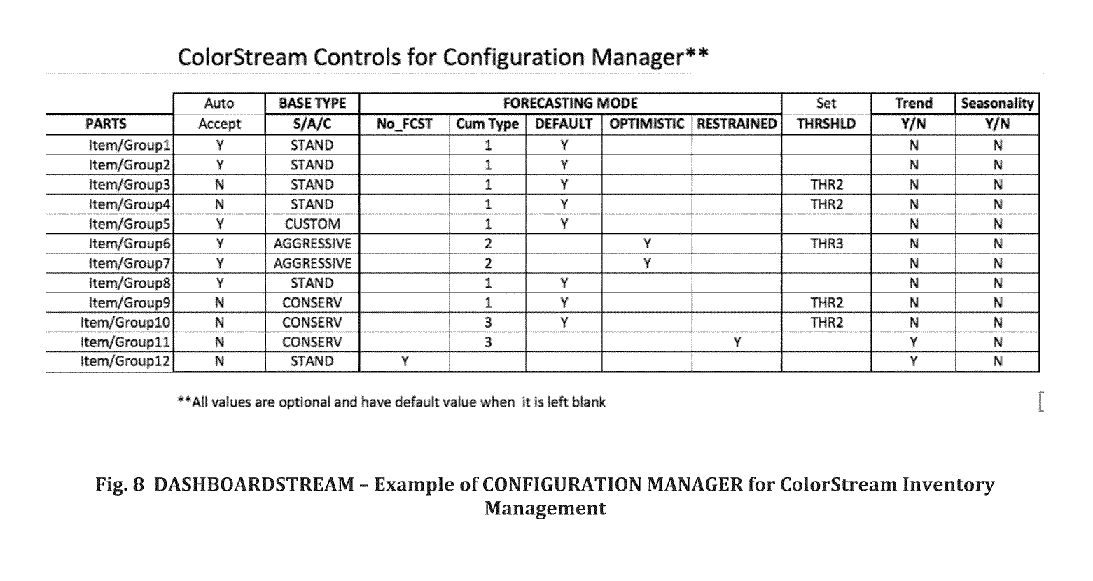

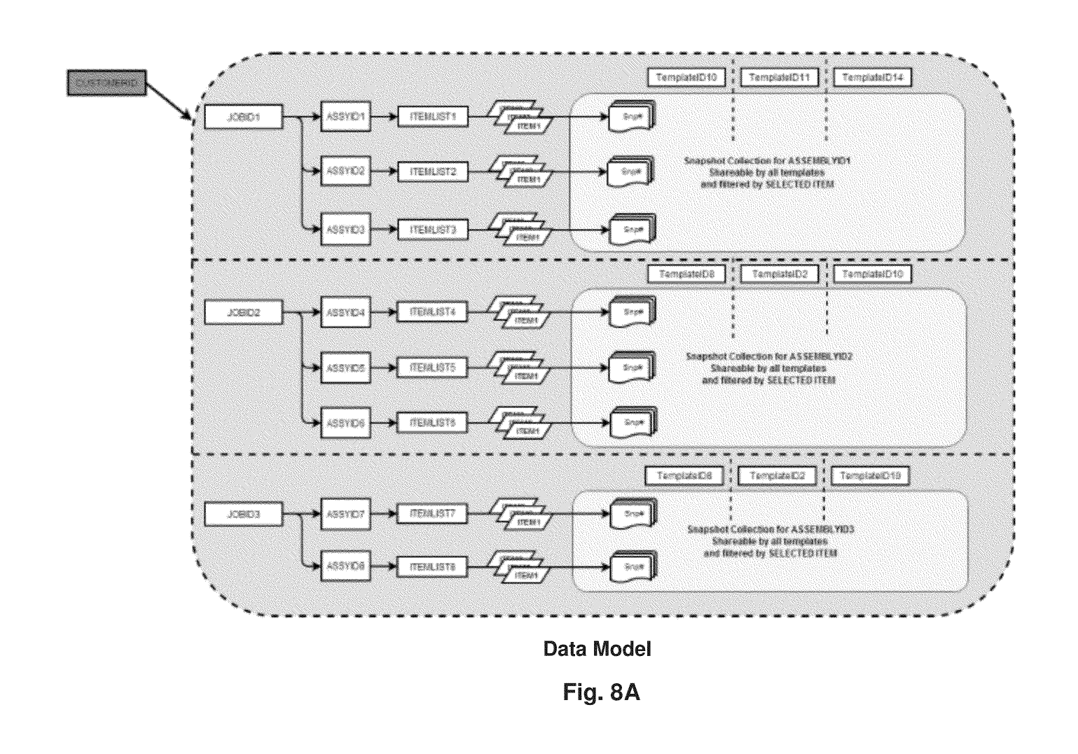

FIG. 8 is a Control Chart of the type used by the Configuration Manager depicted in FIG. 4;

FIG. 8A is a schematic presentation of a data model forming a part of the present invention;

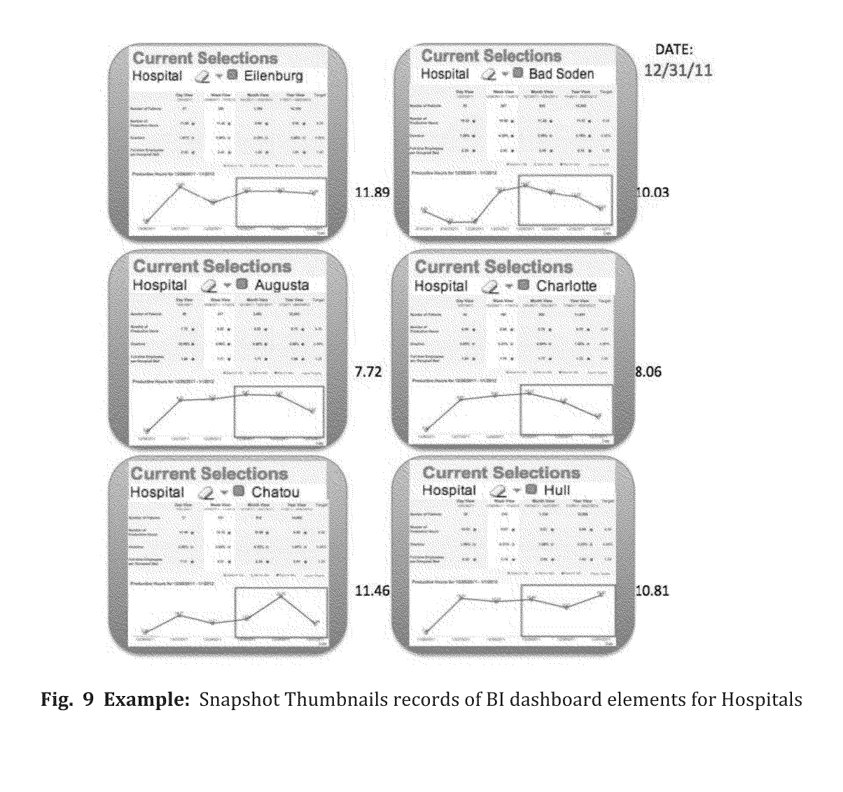

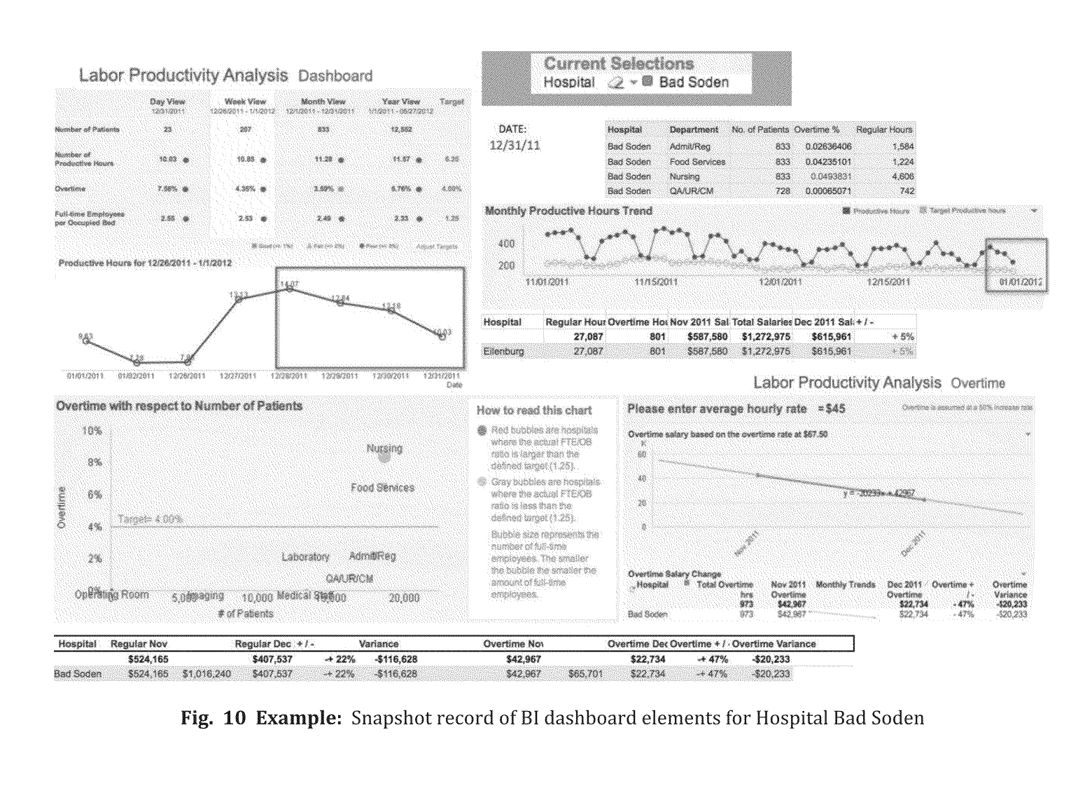

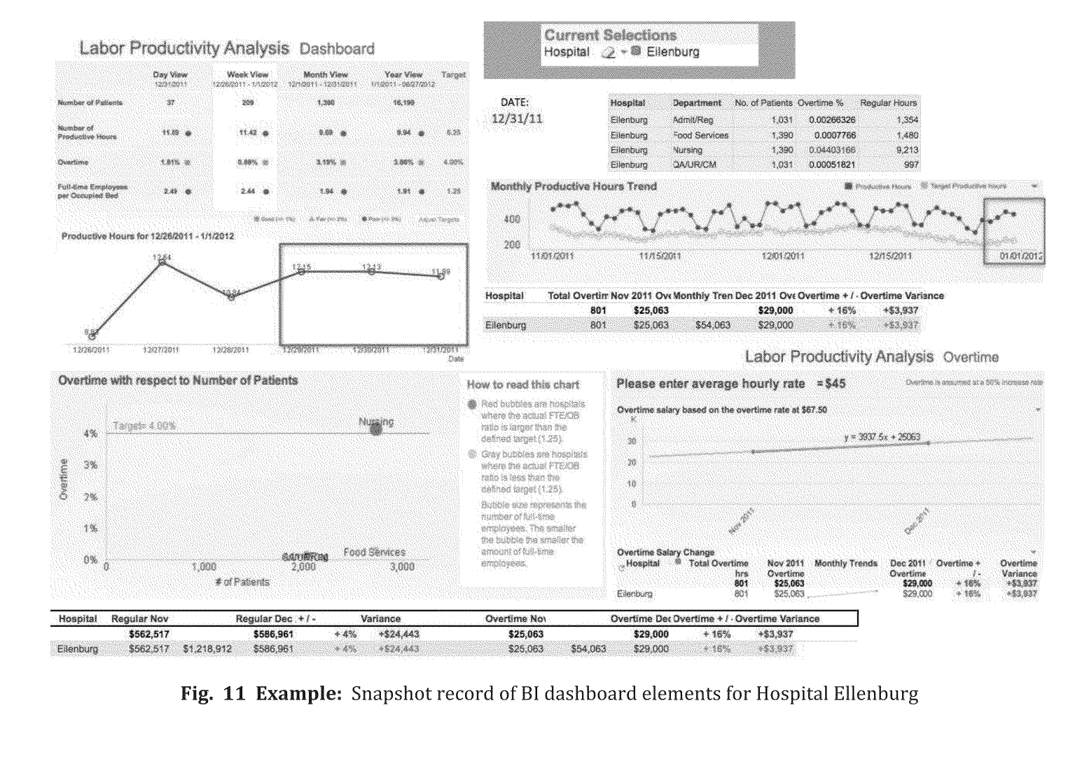

FIGS. 9-11 are illustrations showing examples of Snapshot records of the type displayed on dashboards currently used by hospitals; wherein FIG. 9 is a collection of global thumbnail views, and FIGS. 10-11 are examples of exploded thumbnails included in FIG. 9 (i.e., #1 and #2) showing in full detail snapshot records of related information;

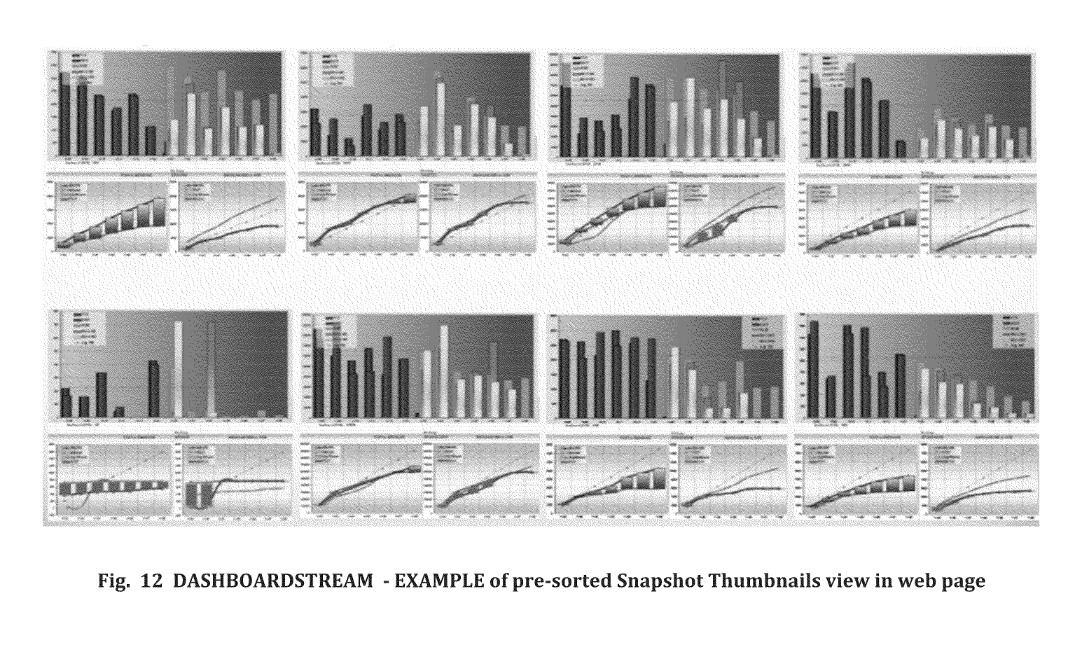

FIG. 12 is an illustration generally showing examples of pre-sorted Snapshot Thumbnails of the type displayed on a dashboard generated by the System and methodology of FIG. 1 and displayed to a customer on a secure web page;

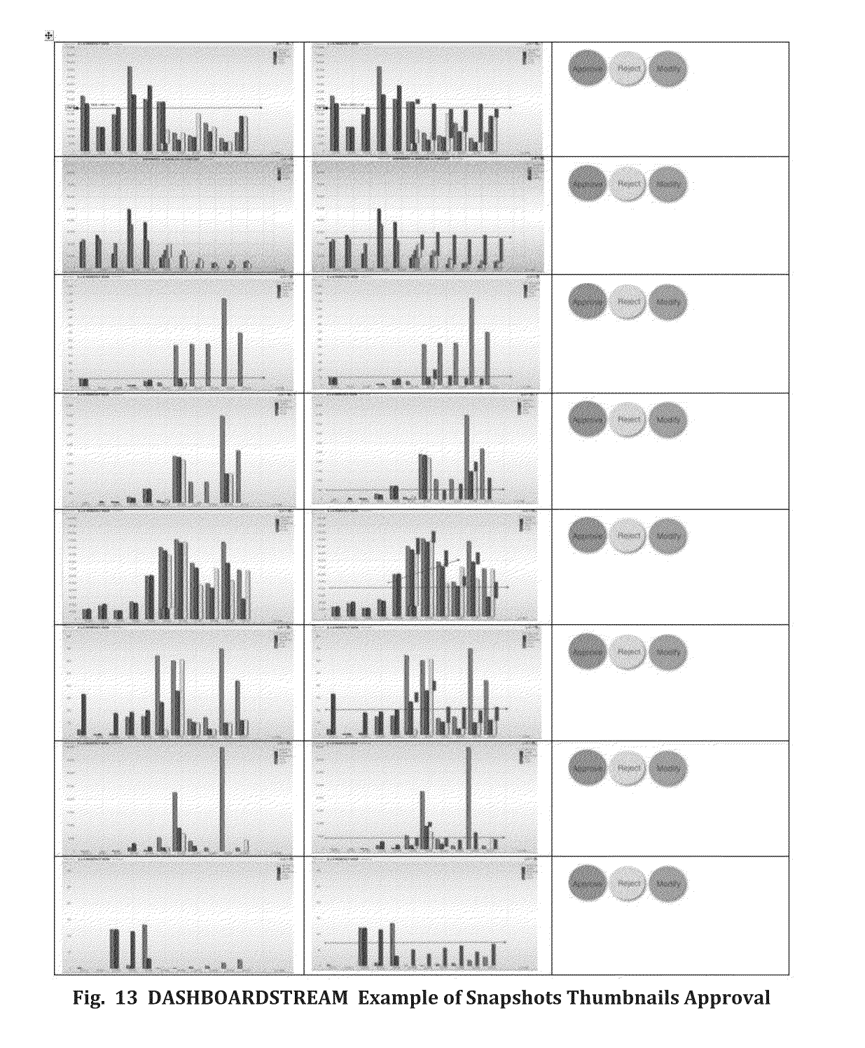

FIG. 13 is an illustration generally showing examples of a Snapshot Thumbnails approval screen of the type displayed on a dashboard generated by the System and methodology of FIG. 1; and

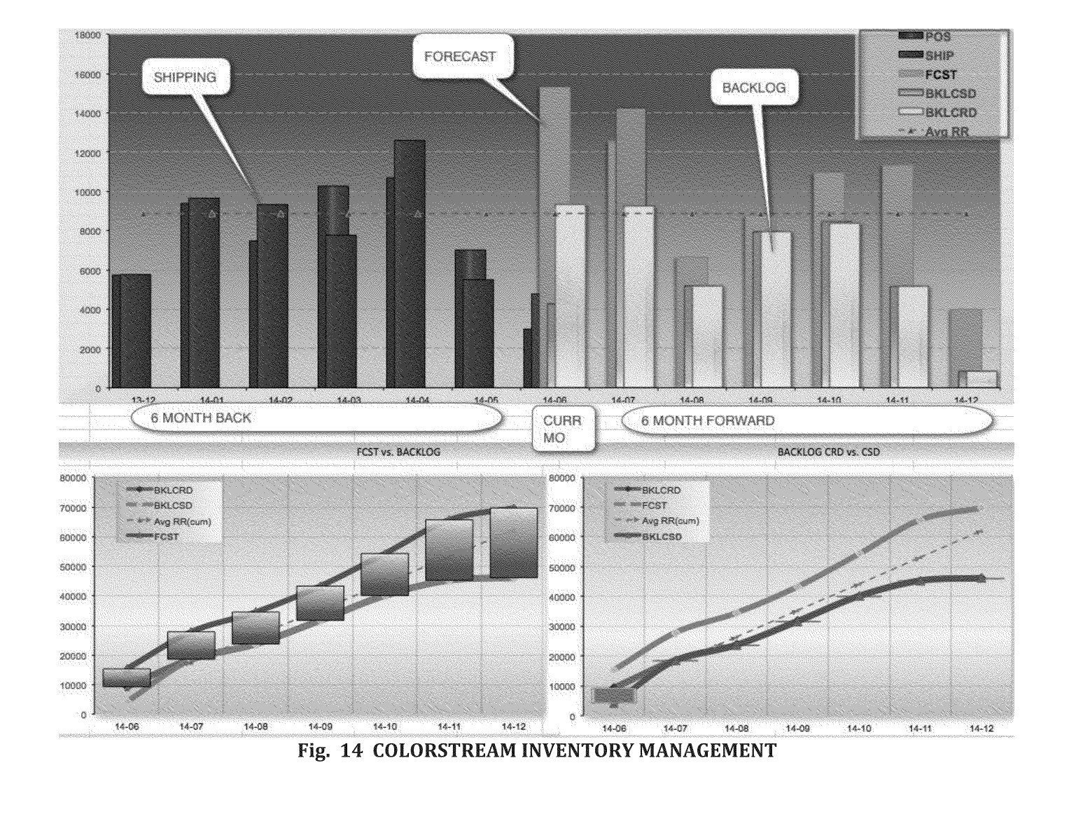

FIG. 14 is an illustration generally showing Inventory Management Snapshots of the type displayed on a dashboard generated by the System and methodology of FIG. 1.

### DESCRIPTION OF THE EMBODIMENTS

The embodiments described herein relate to a novel web based BI dashboard information management service system and methodology, referred to, in accordance with the present invention, as the DashboardStream System for enabling remote subscribing customers to electronically submit their raw business information to the System service provider which in turn will process the information per customer selected rules and templates, and then electronically return (stream) the processed information to the customer in the form of System provided snapshots displayed on a web based customer specific BI dashboard replication made available to the customers on one or more secure and individualized System websites.

Creation of the customer dashboards is handled by the System service provider per specific customer requirements submitted by the customer on initial setup, and includes a business database comprising a plurality of business values, intermediate data, and key performance indicator records in graphical forms depicting key performance indicator values. Intermediate values may be determined using database SQL queries. The customer dashboard is designed to depict the specific performance indicators in explicit visualization formats providing visual clues corresponding to a plurality of customer selected business values.

The System process renders the performance indicator values in consistent key performance format and communicates the indicators to each customer in a corresponding consistent format. The DashboardStream System enables each customer to use the service as a business intelligence (BI) provider without actually possessing its own BI platform. Customer information is presented in dashboard visualizations designed to accommodate customer needs and using customer data feeds, and is delivered in the form of organized collections of System provided graphical snapshots.

More specifically, raw customer data electronically fed to the System service provider via a network is processed in accordance with customer selected requirements and returned (streamed) to the customer in a dashboard static snapshot format addressable by the customer as if it was using its own BI dashboard platform. The visualizations presented to the customer include a personalized display of BI dashboard snapshots developed in accordance with the DashboardStream System methodology and are produced, recorded, organized and streamed back to the customer by the service provider.

A customer dashboard can be built to accommodate various products and businesses in fields including the likes of information technology, medical devices and services, manufacturing operations, logistics services, product and item delivery services, social networking systems, scientific research facilities and much more. The dashboard display components may be replicated in numerous forms suitable for access by computers, laptops, tablets and smart phones, etc.

Referring now to the Drawing, FIG. 1 illustrates in simplified, schematic form within the dashed box 10, the principal operative components of a DashboardStream System in accordance with an embodiment of the present invention. The System generally includes a Processing and Recording Component 12 including a service provider interface means 11 and a BI platform and dashboard 13, an Analytical Component 14 and a customer accessible System Interface Component 16. The System is connected via a data communication network or “cloud” 18 to a plurality of customers 20-N each of which will include some type of electronic data access terminal and visual display device 22 internally linked to a local database storage component 24. Each customer terminal will be capable of providing specific customer specific information and data feeds to the System via the network, and in some cases via the interface 16. The customer terminals can be in the form of one or more personal computers having a monitor, keyboard, disk drive and data communication interface, smart TVs, tablets or PDAs, or any other suitable types of devices. Each terminal must be capable of communicatively connecting with the System via some form of data network via the Internet, a LAN, a WAN or other suitable wired or wireless facility.

In the illustrated embodiment, customer data feeds 26 produced using data contained within the customer's database 24 are extracted and uploaded to a specific direct synced folder (not shown) located in, or associated with, the network 18. Data feeds containing formatted tables are transmitted through well known direct sync technology to the System for processing.

Alternatively, as mentioned above, the customer information and/or documents (data feeds 26) can be delivered to the System using the Interface Component 16. In this case, the data can be manually or systematically uploaded to the System database (not shown) for temporal processing.

The illustrated System Interface Component 16 functions as a direct communication device between the System and each Customer on a secure and individualized basis. Using this Interface Component, each customer can provide specific instructions as to what predefined data should be processed and recorded by the System using the System's BI Dashboard 13, what parameters should be used, and how the System produced snapshots suggested by the illustrated elements 15 should be organized. As will be further described below, the customer can also communicate to the System, through the Interface Component 16, a list of items (a CALL LIST) to be examined by the System.

A customer can also utilize Interface Component 16 to setup operational instructions such as a daily or weekly (or other periodic) schedule, or a specific time when the System Processing and Recording Component 18 must execute the customer's CALL LIST.

Optionally, the operational instructions may contain frequency of operation instructions, specific predefined batch jobs to be used, the delivery method for System produced Snapshot collections and more. The Interface Component can also be used for providing configuration information to the System BI Platform 13 to establish the customer's master BI Template (not shown). Such master Template may take the form of one or more predefined template formats discussed below.

The Processing and Recording Component 12 is used to facilitate the System BI Dashboard in presenting personalized data specific to the customer in a predefined snapshot format. After a transmission and validation of a customer data feed to the DashboardStream System, the Processing and Recording Component 12 will begin its function according to the previously scheduled time and parameters. The Component 12 can be comprised of a standard Business Intelligence (BI) Platform and System proprietary associated control logic for loop processing and recording images, data pieces, spreadsheets and more (not limited) for each item to be individually processed. Alternatively, the BI Platform and associated control logic can be a System proprietary platform developed to meet any special needs or attribute of the System.

Control logic for refreshing the System BI platform, processing data into the BI platform for one item and extracting specific data out of the dashboard for that item resides in specific software code contained within the DashboardStream System. The Processing and Recording Component resides in the System computer terminal 11, which can be embodied as a personal computer, or System server, having a monitor, keyboard, disk drive and data communication interface, or the like.

As initiated by the Component 12, the System BI platform (tool) 13 presents one specific item at a time to the System dashboard. Every time an item changes, the dashboard will re-present new updated views and updated key performance indicator values for that item. The Component will then make snapshots of the dashboard as a whole, or in parts as per the customer requested configuration information. The data snapshots are then organized into records representing each item passed thru the BI Platform by the Component 12. After each processing operation is completed, Component 12 causes the System to finalize the created stack of records 15 (the “full Snapshot collection”).

The System will then prepare a Snapshot Collection for continued processing by the Analytical Component 14 if extra sorting or more analytical sub-processing is required.

The System will thereafter transmit the Full Snapshot Collection over the Network back to the Customer. Optionally, the System can distribute the Full Snapshot Collection to a customer web page (cloud), a sync-direct folder, smart phones, tablets, email, etc

The Snapshots will be sorted and rearranged using a specific algorithm that can be a simple separation criteria, or complex approach methods can be used. The analytical algorithm can be as advanced and/or complex as the customer desires it to be, i.e., there is no limitation on the systematic analysis of recorded data. Sorting and filtering can be applied. Furthermore, a statistical approach can be used to produce calculated breakdowns, explorations and recommendations.

If subsequent further processing of the snapshots is required, the Analytical Component 14 will be utilized. After this processing, the Analytical Component 14 will provide its final results back to Interface Component 16 for customer access and visualization personalized web page where the snapshots will be securely displayed and made accessible to the customer. Although the personal web page is used for snapshots visualization on the Interface Component, customer availability is not limited thereto; i.e., tablets, ipads, smart phones, TVs and other portable devices can likewise be used for the snapshots presentations. Snapshots that went through the Analytical Component can contain, but are not limited to such additional data as recommendations, adjustments, updates and sorted folder structures. A more detailed illustration of the System Processing and Recording Component 12 is shown in FIG. 2. This is the main functional element of the System and Methodology and will generally include a combination of hardware and software components for conducting a systematic processing and recording in a cyclical loop, sorting and assembling process of personalized display elements upon initiation of the BI platform 13.

As illustrated in FIG. 2, the System Processing and Recording Component 12 may be described as including, in addition to the BI platform 13, a server 30 having a Call item picking stage 32 (PICK), a Configuring function stage 33 (CONFIG), an Assembling function stage 34 (ASSEMBLE), and an RUN function stage 35 (RUN). System component 12 also includes a Call Register 36, a Configuration component 38 controlled by the Server and linking Call Register 36 to the BI dashboard 13, and an Assembling component 40 controlled by the Server and linking BI dashboard 13 to the Call Register 36. Server 30 is also linked to the System Database Storage unit 42, the User Interface (UI) Operation Manager of Interface component 16, and the Analytical component 14. The BI dashboard 13 is linked to a Master BI template 44. The UI Operation Manager of Interface 16 is also coupled to the Call Register 36.

Synchronized feed data from the customers contained in the associated Direct Synced Shared Folders 46 of network 18 is continuously updated and used to refresh the BI Dashboard 13 of System component 12. After the BI platform is refreshed at a specific time, and its update is validated, the System Component 12 initiates operation of Server 30 based on the set schedule established by the Operational Manager residing in Interface Component 16. It will also align the customer specific Master Dashboard 44, or other dashboards identified by the Operation Manager. The Server starts and controls the process of recording static snapshots by retrieving one item at a time from the register 36 as specified by the CALL LIST provided by the customer. Controlled by the System software in Server 30, the System will retrieve one item from the register 36 for processing and push it to the Configuration Component 38. At the next cycle stage (CONFIG) the Configuration Component 38 will validate the configuration settings for the item. Each item may have its own unique configuration parameters identified in the CONFIGURATION Manager of the Interface Component 16. The Configuration Component 38 will determine specific elements to be recorded in the BI template, the number of elements, charts, tables etc. During the next cycle stage, the System software logic will place the item into the BI platform for analysis.

The RUN stage 35 is the execution portion of the BI platform 13 wherein the customer's personalized dashboard application will be recorded for that specific item. Dashboard 13 (or other dashboards prepared by or for the customer) may have multiple views, pages, charts and graphs and more, and may contain multiple key performance indicators in a customer specific Master Template 44.

There is no limit of the data to be inspected and recorded by the System Processing and Recording Component 12. A particular Customer may wish to use full snapshot views in the form of textual, graphical and other ways of presentation for every element of the dashboard. That data, called a Record, is thus collected and compiled into a presentable condensed view for the customer as they have requested.

The Assembling Component 40 will contain specific recording software logic that will be used during the Assemble stage 34 (ASSEMBLE) to finalize the record, organize it and compile snapshots of the data into one Record for this inspected item. To complete the cycle, the Server 30 moves the finished Record (Snapshot) into the Database Storage unit 42 before retrieving the next item from the register 36 for processing. After the full round of data collection for one item in the BI dashboard 13 is completed, its cycle is completed, the PICK will begin, and Processing and Recording Component 30 will repeat the same process for the next item on the CALL LIST.

Records are stored in the Database Storage unit 42 before they will be processed as a Full Collection and forwarded to the Direct Sync Folder 46 (as suggested at 48 in the Drawing).

When the last item on the CALL LIST is processed, Component 12 will send a completion signal to the Server 30 and the Full Snapshot Collection will be processed into the customer's personal web page in the Interface Component 16 and/or the Full Snapshot Collection will be moved to the Direct Sync Folder 46.

Optionally, the Server 30 may send the Full Collection to a mobile App and/or email it for immediate customer view and inspection by a representative of the company.

The Assembly Component 40 may also send the Full Collection of Snapshots to the Analytical Component 14 for further processing.

If a customer wishes to apply any additional logic to find and sort items based on specific criteria, he may provide its logic using the Configuration Manager of the Interface Component 16.

Finding issues or problematic items based on specific parameters and/or sorting items in the static snapshots based on customer provided rules is a superior advantage of the Analytical Component 14 of the Dashboard Stream System.

As stated above, the DashboardStream System and Methodology does not require a customer to obtain its own BI platform. This is to say that a subscribing customer may in effect use the System's business intelligence platform as if it was his own without owning one and operating it himself.

Similarly, rather than using a commercially available BI dashboard platform, the Dashboard Stream System may develop and operate its own proprietary platform to do custom analysis and deliver results to the customer in the form of static Snapshot images of complete or abridged data.

The Analytical component of the present invention is used where a customer requires global searches on detailed levels. Use of this component may be applicable to any business, system, web, or network. Also, the customer may choose to utilize the specific logic of my ColorStream Inventory Management System for identifying and recommending actionable systematic adjustments to forecast or manage its inventory levels. These recommended adjustments will be called—Recommendations. The ColorStream Inventory Management System is the subject of my co-pending U.S. Patent Application Ser. No. 62/018,516, filed Jun. 28, 2014, and incorporated herein in its entirety by this reference.

Turning again to the Drawing, FIG. 3 is an illustration of the Analytical Component 14. This component includes a Recommendations Generator 50 which uses proprietary analytical algorithmic software to perform further analysis on a Full Snapshot Collection. The component includes a filter stage 52 (FILTER), qualifying logic 53, a Sort stage 54 and a Distribution Component 56 including a plurality of Corrective Action Folders 60. In operation, one record at a time taken from a copy of a Full Snapshot Collection will be processed through the Recommendations Generator 50. This component has specific processing Algorithmic software designed for DashboardStream. It also uses configuration settings from the Configuration Manager of Interface 16. When a Record (1 item Snapshot) is taken to the Recommendations Generator, its processing algorithm will inspect the applicable elements. If it does not pass inspection criteria, the record will be discarded. Records that meet established criteria will be pre-filtered and moved to the Sorting stage 54. The sorting of Records controlled by the Analytical Component and its logic is based on customer rules established ahead of time through the Configuration Manager. The Records may be stripped, filtered or abridged during this process depending on customer requirements.

The sorting stage will conduct a re-distribution operation for the Analytical Component. During the SORT operation, Snapshots will be allocated to individual folders. In FIG. 3 these folders are called Corrective Action Folders. DashboardStream may include an unlimited number of folders, with each folder having a specific, unique meaning and task—like for example, “Rejected Items” folder, “Items with Criteria1” or “Items with Criteria2” etc.

Associated data like Recommendations are adjustments generated by the System. RECOMMENDATIONS—are business intelligence analytics. They may be as simple as searching, filtering and sorting tasks, or they can be complex and multifaceted prescriptive analysis. There is no limit for analysis with BI platform utilization.

Recommendations are produced by the Recommendations Generator 50 during DashboardStream's Analytical Component process and they are added to each associated record. After that point each Record or Snapshot that had attached Recommendations will be stored and treated in the database independently and processed into the Interface Component customer personal web page specific location for recommendations.

In FIG. 4, the principal components of the Interface Component 16 are shown to include a Display User Interface (UI) Component 60, a User Interface (UI) controlled Operation Manager 62, a User Interface (UI) controlled Configuration Manager 64 and a Validation component 66.

The UI Display Component 60 is a computer monitor screen or TV, tablet or other device capable displaying data. The Operation Manager 62 is a user interface that allows the customer to input controls for the following parameters (but is not limited thereto): batch job, customer ID, delivery method, frequency, timing schedule, Call List and dashboard to be used, and perhaps other important parameters required for operation of the Recording Component 12. An example of Operation Manager inputs to the System is given in FIG. 7. The Configuration Manager 64 is a user interface that allows the user to input control parameters for the Analytical Component 14. Specifically, it is used to enable a customer, or the Service, to enter sorting criteria, filtering purpose, and to support business intelligence analyses from simple to complex. An example of Configuration Manager inputs to the System is given in FIG. 8.

The Validation Component 66 is used during the Recommendations approval process. Recommendations (Prescriptive data) are reviewed by the customer with the visual support of snapshots as suggested at 65. All recommendations are visible in the snapshots, and the customer can make judgments and decisions immediately when reviewing a static image of the BI Dashboard. If a decision is made to reject a recommendation—the System (DashboardStream) will discard the recommendation for that specific item and will remove it from the list of recommended adjustments, which have earlier been prepared to be processed into the customer system.

If the customer accepts a Recommendation—its prepared adjustment will be ready to auto feed to the customer system. Recommendations are pre-aligned for easy automatic processing into the customer's system. After a customer completes its full review of the pre-filtered and sorted Recommendations, one more step is required to finalize the process: a confirm button must be clicked on the customer's personal page (Display Component). Final confirmation (Validation component 66) will release the complete set of Recommendations into the customer systems for processing.

In FIG. 5, an example of a Call List is presented. A Call List is a list of items for inspection and system recording, and is usually provided by the customer, or by the Service provider with the approval of the customer. The number of items on the list is virtually unlimited. The customer manages his Call List using the User Interface 64. T Call List is a separate file which can be uploaded on the DashboardStream website directly to the Operation manager 62, or be provided with a set of other input files through the Direct Sync Shared folder 46 on the network. Or it can be sent by email to the service provider. This file (CALL LIST) will subsequently reside in the DashboardStream Server and has the following parameters specified:
PARTS (Item or Group ID)—a unique item or group of items to be inspected and have static snapshots be recorded from the BI system.
CUSTOMER—an identifier or reference to a specific customer.
Batch JOB—a given name of the batch job run identifying resources to be used, and specifics of assigned run or special algorithms.
Folder NAME—a System folder assigned for snapshots storage.
Batch Time—Actual Start time for the operation.
6-9 Logs of specific actions from previous runs Including
   Last RECOMMENDED
   Last ACCEPTED
   Last MODIFIED
   Last REJECTED.

Log records are not only for display of information, but may play a separate role in the System operation during the Approval process, allowing the System to create certain actions based on the log records. As an example, if an item was previously rejected by the customer during the Approval Process: this item will have a log record of “Last REJECTED=5/20/2014”. The DashboardStream System will automatically create a separate sub-folder for this item record with the Name—“REJECTED”. It will allow separate flow, treatment and representation of those item snapshots which were previously rejected. Like, if RECOMMENDATION is provided for the same item, however, its data will be excluded from regular adjustments. This way it will provide better visibility, protection and simpler handling of prescriptive analysis.

Before the System can start processing a prospective customer's data, in addition to the normal establishiment of the business relationship, an initial setup process must be completed so the System will have the information necessary to allow it to perform the DataboardStream functional operations. This process can be accommodated at least in theory by a set of menus or questionaires like those schematically depicted in FIG. 6A and might include the establishment of a Shared Sync Folder as suggested at 67; a Data Feeds Setup process 69 for determining what types of data is to be fed to the System and how and when it is to be fed; an operational menu 71 for establishing the customer's operational requirements; a configurational menu 73 for establishing the customer's configuration requirement; a CallList menu 75 for establishing the Call List input rules to be followed; an Analysis menu 77 for inputting the customer's analysis requirements; a Display Format menu for establishing the customer's display requirements; and a user Interface menu for establishing rules relating to the customer's use of the of the System interface. This information will involve a cooperative effort with the DashBoardStream Service Provider to insure that the System can perform it's intended service.

At the Service Provider side of the System the Shared Sync Folder 83 process will have to be setup; the Database Storage facility 85 will have to be setup; the new Customer User Interface 87 will have to be established; and operational details relating to the Server 89 will have to be setup.

Further items that will need to be dealt with include the BI Dashboard Design or Template 91; the setup of the Configuration Logic 93; the necessary Operational Data 95; the Recording Logic 97 an the Analytical Logic 99. Once all of these items are properly setup, the relationship with the customer can begin and the Service can be commenced.

In FIG. 6B the principal functions of the DataBoardStream are graphically summarized and include the use of a suitable communications network as is disclosed in detail herein for receiving the customers' data feeds; a System server function 103 for implementing the DashBoardStream proprietary System software; the processing function 105; Recording function 107 dashboard data Assembly function 109; and Distribution function 111. In addition, when requested by a customer, the System will perform an Analysis function as disclosed in detail herein.

As illustrated, the distribution function will normally send the System output product to a System DataBase 119 which will facilitate the distribution and Results Display 117 to the multitude of customer web pages of the System, Similarly, the Analysis product may be sent to the DataBase 119 for distribution. In addition, as disclosed herein in detail, certain Recommendations can be sent directly to the customers' web pages as illustrated at 115.

In FIG. 6C, an embodiment of a PROCESS FLOW DIAGRAM is presented showing the principal flow of events (operative steps followed) during operation of the DashboardStream process. In the upper left corner of the diagram, “Time” specifies that the process for a particular customer is set to start; the time is indicated as being 7:00 AM. This time corresponds to the timing setup in the Call List for this specific customer. When the process is initiated at 7:00 AM, as indicated at 70, the System checks data readiness in the Synced Folder (46) to see if the files were updated or refreshed after the last run. If they were updated, confirmation is sent to the System, and the Operation Manager (62), using customer specific information and parameters, prepares the Business Intelligence platform (13) to begin its operation as indicated at 72, and reloads (updates) the BI system with the updated data in the Shared network Folder as indicated at 74.

After the BI system is reloaded the Server (30) starts the DashboardStream snapshot recording process as suggested at 76 and processes one item at a time in cycled phases (one cycle per item on the Call List) as previously described in FIG. 2. By pulling one item at a time from the BI dashboard for processing the Server as indicated at 78 uses outputs from the Configuration Component to set parameters and identify the objects (data and images) to be recorded for the called item, applying specific configurations if required.

In the Run phase 80, the BI Tool is caused to generate images and graphs in the BI Dashboard and cause execution of the individual snapshots of data, graphs tables, etc. The results of the Run are then passed to the Assembly phase 84, where the item results are compiled and the data is assembled into Records and stored in the database 42. Each item in the Call List flows through the same processing phases.

After the last item on the Call List has been processed, a complete set of records, now called a Full Snapshot Collection, as suggested at 48, is complete and it will be stored in the System's storage unit 42 and made ready for distribution by the DashboardStream system as indicated at 90. The transfer can be made using the following routes (but is not limited thereto):
Customer Sync Shared Folder (92);
Customer Web Page (94) (Display component of UI);
Mobile app display (96); or
Email (98).

In summary, during each RUN or execution cycle, an item identified in the Call List is placed into the BI platform component 13, the System is refreshed, and the identified parameters in Configuration Manager 64 are recorded by the DashboardStream System. Snapshots are taken in multiple places of the dashboard(s) designated by the customer. The Snapshots represent explicit facts and essential details, which are important to the customer. Snapshots that are used in photography and image processing can be recorded in multiple formats such as for example: portable network graphic images (png), jpeg, gif, tiff, bitmap and many more.

Also, the Snapshots in computer storage; a set of computer files and directories kept in storage, as they existed at some previous time, can be used in combination with the image snapshots currently in the BI dashboard system. A computer storage snapshot primarily creates a point-in-time copy of the data. Typically, a snapshot copy is made instantly and is made available for use by other applications such as data protection, data analysis and reporting, and data replication applications.

The Assembly stage is used for putting together parts of recorded images from the BI Dashboard into presentable condensed views and also creating a thumbnail of such view for easy viewing and understanding. Normally, in a display on a personal customer webpage, the first view is a thumbnail view of each item, as it is shown in FIGS. 9-11. For easy recognition and reading of thumbnails; each thumbnail may contain clearly visible critically important pieces of information which have been identified by the customer.

Each item thumbnail will have a link to an expanded view of the recorded snapshot so the customer can, if he wishes to do so, expand it for further analysis. The Assembly Component sends each Snapshot as an item Record to the internal storage.

FIG. 7 is an example of the data input by the customer into the Operation Manager. The Operation Manager maintains the DashboardStream System controls and uses the following parameters:
Batch Job
Customer name
Delivery Method of Snapshot Collection (i.e. Web, Sync Folder, email)
Frequency of DashboardStream system run
Time—start of the process
Call List to be used
Dashboard elements to be recorded
Other parameters related to specific customer measures

FIG. 8 is an example of customer inputs to the Configuration Manager, which is responsible for control of detailed parameters to be used in providing predictive and prescriptive analysis and recommendations, its acceptance criteria and auto regulation. In this example, the controlled parameters are those used in the above-identified ColorStream methodology, which deals with forecast regulation and auto adjustments. Further details of such methodology are disclosed in my co-pending U.S. patent application identified above and incorporated herein by reference.

As disclosed above, the DashboardStream recording process produces hundreds if not thousands of snapshots of each Customer's analytical data. Such snapshots are developed and temporally stored by the BI component of the System. In order to present such data in an immediately perceptible form to a Customer, the snapshots are timely and selectively used to populate various ones of a collection of predefined TEMPLATES to produce RECORDS. In an embodiment of the present invention, various ones of the same collection of TEMPLATES may be used at the same time in separately reporting proprietary analytical results to many customers requesting or requiring the same or similar types of analyses.

Each TEMPLATE may be thought of as a specific pattern within which a specific collection of various forms of snapshots, tables and texts are organized and attributed to underlying assemblies of analytics that are linked together to present different visualizations, views and/or details of the same or at least related business data hierarchically, laterally or longitudinally related to other data. The TEMPLATES are variously used as reporting structures to simultaneously present, in a glance, different aspects of a Customer's analytical data in specific forms, layouts and shapes that are not only visually perceptible, but ones that are designed to assist the Customer in more efficient data digestion and understanding, and at the same time allow the Customer to at will, instantly drill down to more precise and inclusive presentations of the data.

Referring now to FIG. 8A, a DATA MODEL in accordance with the present invent is schematically depicted and presented in the form of a structural “SCHEMA” or design. In this diagram:
CUSTOMERID is the name of a particular CUSTOMER or subscriber to the D.
JOBxx is the name given to a particular “analysis” or “set of analyses” to be undertaken for this CUSTOMER (i.e., Sales analysis, Expense analysis and/or Inventory analysis). It is the highest layer in the SCHEMA for a particular analysis. The customer may have one or many analyses which are performed to gain visualization of statistical information.
ASSYxx is the name given to a particular set of data presentations to be generated relative to the “analysis” or “set of analyses” under this JOB. After an analysis has been established for Expenses, it can be broken down into multiple sub-layers; for example, EXPENSES—12 MONTHS VIEW, EXPENSES BY VENDOR, etc.
ITEMLISTx is the name given to a particular set of instructions regarding the number of elements to be recorded by the BI system for every analysis, the sequence of the recording process, the format of the recording (for images and tables), and the location where the recorded data is to be stored.
ITEMx is an abstract name used in the DashBoardStream recording process that identifies a Record; it can identify a specific item in the customer inventory, or it can be a figurative or descriptive name that is used to identify a snapshot to be included in a RECORD, i.e., “Overview” or “Items—13 week View”.
SNPT# is a snapshot ID number. It is an actual unique snapshot element ID that is recorded in the Business Intelligence system. It may identify a specific chart, or a specific table, or a specific selection box; i.e. an element of the BI system.

FIG. 11 is an example of a RECORD; i.e., a populated TEMPLATE for the CUSTOMER “Hospital Ellenburg”. In this case ASSEMBLY identifies the particular set of Snapshots to be included in the RECORD, as well as the relative positions of each Snapshot included in the RECORD.

In the present DashboardStream process of data processing and review, the first level of customer interaction with the data is in the form of thumbnails. As is well known, thumbnails are usually small interactive images of a representative nature that can be expanded to reveal other information. However, in an embodiment of the present invention thumbnails may be of several sizes revealing at a glance the subject matter interactively lying there beneath. Clicking on a thumbnail results in an “explosive” process revealing the data presentations included in a related data populated Template. Examples of various thumbnails as referred to herein are shown in FIGS. 9, 12 and 13.

In accordance with the present invention, a “Direct Link” type of Task Management feature is also provided. This feature is designed to not only manage notes, priorities, due dates, etc., like any classic TM system, but also includes direct links to saved snapshots included in the various previously reported Templates to allow current specific analyses of selected items (views) vis a vis its previous state. Accordingly, a Customer or the service will always be able to compare or conduct an analysis of the past state of one or more selected Items with the current status of the same Items. And if a task is delegated to another user or client, the Direct Link is accessible at any time by both parties.

In one embodiment, this feature is implemented by saving a separate “Clip” Template that is fixed to a specific time frame and relates to data as it existed at a particular point in time; for example, when the related analysis was first conducted. The current and corresponding reporting Template will thus include an “Item” link selection feature that is directly linked to corresponding items in the Clip Template. Accordingly, tasks that are delegated to other users are manageable by both parties (owner and delegated user) and both parties have continuous access to the Items (past and current states).

FIG. 9 is an example of Snapshot thumbnails for a BI dashboard built for the hospital business. There are 6 thumbnails viewable in the example, each displaying corresponding partial data relating to a different hospital and depicting critical parts of the graphical image, and providing visual clues in the rectangle in the lower right corner of each thumbnail. It also lists a number of the critical parameters for each thumbnail item for easy gazing. Visually, the user can quickly scan through the thumbnails to gain an understanding its data and skip the non-critical items. If the user decides to explore the item represented by the thumbnail—he can click on it and expand it into a full snapshot view like the two represented in FIGS. 10 and 11 hereof.

FIG. 10 is an expanded view of the Snapshot Represented by the Thumbnail in upper right corner of FIG. 9 with the Key Indicator=10.03. A lot more static data and graphical information has been captured in this view. This snapshot may be a full screen image capture from the BI dashboard or it may be pieces collected from different parts of the dashboard.

FIG. 11 is also an expanded view of a Snapshot represented by one of the thumbnails of FIG. 9. In this case it is the thumbnail in upper left corner with the Key Indicator=11.89. If the images of FIGS. 10 and 11 are compared side-by-side, it is clear how much of distinctive info can be packed into one Snapshot and how much they can vary. The uniqueness of Snapshots used for business intelligence information gathering with utilization of modern BI platform is in their versatility, flexibility and adaptability.

FIG. 12 is an example of Snapshot thumbnails for a BI dashboard built for an Inventory Management System. There are 8 thumbnails view in this example, and each Thumbnail shows only a graphical image of an inventory state including a monthly view of historical shipments and current orders plus forecast.

FIG. 13. Is an Illustration of Approval flow in accordance with the present invention. On the personal customer web page there will be buttons provided next to each thumbnail for “Approve”, “Reject” or “Modify” action. The DashBoardStream System will act according to the customer's decision:

If “Approve” is picked, then the System will process the Recommendations for the given items to make forecast adjustments in the system. It will be a systematic process aligned and agreed to by the customer.

If the customer chooses “Reject”—The Recommendations for this item will be discarded and a log created. The next time item comes up, DashboardStream will respect it and keep in memory the users (customers) selection, and will keep this item outside of the automated processing.

If the customer chooses “Reject”—The Recommendations for this item will be discarded and a log created. The next time item comes up, DashboardStream will respect it and keep in memory the users (customers) selection, and will keep this item outside of the automated processing.

If the user chooses “Modify”—the system will allow intervention and manual modification of the Recommendations.

To understand Inventory Management view, refer to FIG. 14 for an explanation. In the Inventory Management System Snapshot illustrated in FIG. 14, a single, specific Master template is employed which is easily adaptable to any business of any size. This template maintains minimal points of interaction with other systems and uses calculated corrections (i.e.—“RECOMMENDED FORECAST”) as a final output at the end of the process run.

A few of the following factors will almost always provide both large and small companies a good understanding of a business's status and condition. As illustrated in FIG. 14 main revealing parameters are:
A. Shipments (historical data)
B. Backlog (Open orders)
   Backlog CRD—backlog represented by customer requested dates
   Backlog CSD—backlog represented by scheduled dates
C. Forecast (Future open orders)

As is visible looking even at the small image in this thumbnail, a user can pick up differences and can distinguish issues and potential gaps. Images and thumbnails can be presorted into different folders per rules established by the customer, so it will help to focus only on outliers and exceptions.

The Lower portion of FIG. 14 shows two graphs depicting comparison of cumulative monthly data of Forecast vs. Backlog (left) and Backlog CRD vs. Backlog CSD (right). These graphical images even in small size may provide enough information to trigger user interest for deeper analysis.

The preceding description provides preferred exemplary embodiment(s) only, and is not intended to limit the scope, applicability, or configuration of the invention. Rather, the description of the exemplary embodiment(s) is intended to provide those skilled in the art with an enabling description for implementing an embodiment. It is to be understood that various changes may be made in the described methods, processes, functions and arrangement of elements without departing from the true spirit and scope of the invention.

1. A System, service and methodology of data collection, analysis, processing and effective delivery of individualized analytical reports in the form of dashboard organized information to multiple service customers, comprising:
an interface and communications component remotely accessible by each of a plurality of customers on a secured basis; and
an analytical service provider for receiving proprietary data from each of the plurality of customers in raw data format via said interface and communications component, the service provider including a data processing, assembling, recording and delivery component for developing customized analytical dashboard configured reports of each customer's data in individualized dashboard snapshot data formats organized according to one or more predefined templates provided by the service provider and selected by each customer, the service provider communicatively forwarding the individualized reports to the respective customers for dashboard visualization on a customer provided graphical display device.

2. A System, service and methodology as recited in claim 1 wherein said service provider is linked to the plurality of customers via a pass word protected web based communications link.

3. A System, service and methodology as recited in claim 1 wherein said data processing, assembling, recording and delivery component includes
a system server including control logic for loop processing and recording images, data pieces and spreadsheet data relating to each item of customer data to be individually processed;
and
a business intelligence platform operatively associated with said system server and configured to develop multiple iterations of snapshot data reflective of the analysis of the customer's data and suitable for populating the customer selected Templates with snapshot data.

4. A System, service and methodology as recited in claim 1 and further comprising:
an analytical component for enabling the service provider to quickly analyze the customer's processed data on an individualized basis as requested by the customer, and to additionally provide actionable recommendations for consideration by the customer.

5. A System, service and methodology as recited in claim 1 wherein said service provider is linked to the plurality of customers via a pass word protected web based communications link

6. A System, service and methodology as recited in claim 1 wherein said service provider is linked to the plurality of customers via a direct sync shared folder on a web based network communications link.

7. A process of obtaining raw business data from remotely located customers, analyzing the data and returning business analytical data visualizations to the customers comprising:
providing a plurality of customer selectable Templates adapted to organize and display certain types of snapshot data information in a predetermined organization and configuration;
using a network based interconnection and associated interface component to remotely obtain proprietary business data from each of a plurality of customers;
using a business intelligence tool to individually process and analyze the proprietary data received from each customer and to develop and store multiple snapshots revealing various details of the results of the analysis;
populating one or more of the Templets selected by the customers to produce customer records providing dashboard visualizations of the snapshot data; and
communicating the dashboard visualizations to the customers using the network based interconnection and associated interface component.

8. A process as recited in claim 7 wherein a secure website is used to individually provide communication of the dashboard visualizations to the customers.

9. A process as recited in claim 7 wherein the dashboard visualizations are obtainable by the customers from the website using any electronic communications device capable of receiving and displaying graphical data.

10. A process as recited in claim 7 wherein the snapshot data included in the populated Templates is linked to further snapshot data underlying and linked to the data depicted in the populated Templates thereby enabling the using customer to drill down to one or more granulations of the data.

11. Apparatus obtaining raw business data from remotely located customers, analyzing the data and returning business analytical data visualizations to the customers comprising:
means for providing a plurality of customer selectable Templates adapted to organize and display certain types of snapshot data information in a predetermined organization and configuration;
means using a network based interconnection and associated interface component to remotely obtain proprietary business data from each of a plurality of customers;
means using a business intelligence tool to individually process and analyze the proprietary data received from each customer and to develop and store multiple snapshots revealing various details of the results of the analysis;
means populating one or more of the Templets selected by the customers to produce customer records providing dashboard visualizations of the snapshot data; and
means communicating the dashboard visualizations to the customers using the network based interconnection and associated interface component.

12. Apparatus as recited in claim 11 wherein a secure website is used to individually provide communication of the dashboard visualizations to the customers.

13. Apparatus as recited in claim 11 wherein the dashboard visualizations are obtainable by the customers from the website using any electronic communications device capable of receiving and displaying graphical data.

14. Apparatus as recited in claim 11 wherein the snapshot data included in the populated Templates is linked to further snapshot data underlying and linked to the data depicted in the populated Templates thereby enabling the using customer to drill down to one or more granulations of the data.
